(19) United States
(12) Patent Application Publication
(10) Pub. No.: US 2012/0066249 A1
(43) Pub. Date: Mar. 15, 2012

(54) UTILIZING HIERARCHY METADATA TO IMPROVE PATH SELECTION

(75) Inventors: Christopher A. Hays, Monroe, WA (US); Aaron S. Meyers, Kirkland, WA (US); Robert A. Meyers, Redmond, WA (US)

(73) Assignee: MICROSOFT CORPORATION, Redmond, WA (US)

(21) Appl. No.: 12/882,166

(22) Filed: Sep. 14, 2010

(51) Int. Cl. G06F 17/30

(52) U.S. Cl. 707/769; 707/E17.014

(57) ABSTRACT

Embodiments are directed to implementing hierarchy metadata to improve relational model default path selection heuristics. A computer system receives a database query from a user. The query is configured to return a portion of requested data stored in the database. The database includes multiple different data entities related to each other via different relationship paths. The computer system accesses hierarchy metadata that describes various database hierarchies, each hierarchy including multiple data entities. The computer system determines an optimal path between the related data entities based on the database query and the hierarchy metadata, and accesses the data using the determined optimal data entity relationship path.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to provide reports or layouts that include various types or categories of information. For example, a user may request order data from a database that includes all orders to shipped to a certain geographic region within a certain time period (e.g. all orders shipped to New York within the month of June). The requested information is retrieved from a database and presented to the user in the form of a layout or report. The layout or report, however, may be formulated in many different ways. Determining precisely which information the user would want presented is not easily accomplished.

### BRIEF SUMMARY

Embodiments described herein are directed to implementing hierarchy metadata to improve relational model default path selection heuristics. In one embodiment, a computer system receives a database query from a user. The query is configured to return a portion of requested data stored in the database. The database includes multiple different data entities related to each other via different relationship paths. The computer system accesses hierarchy metadata that describes various database hierarchies, each hierarchy including multiple data entities. The computer system determines an optimal path between the related data entities based on the database query and the hierarchy metadata, and accesses the data using the determined optimal data entity relationship path.

In another embodiment, a computer system receives a database query from a user. The query is configured to return a portion of requested data stored in the database. The database includes multiple different data entities related to each other via different relationship paths. The computer system accesses hierarchy metadata that describes various database hierarchies, each hierarchy including multiple data entities. The computer system determines each relationship path between a starting entity and a target entity, compares unique portions of the relationship paths that are not shared between relationship paths, and removes those paths determined not to be an optimal path between the related data entities. The computer system determines an optimal path between the related data entities based on the database query and the hierarchy metadata, and accesses the data using the determined optimal data entity relationship path.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including implementing hierarchy metadata to improve relational model default path selection heuristics.

FIG. 2 illustrates a flowchart of an example method for implementing hierarchy metadata to improve relational model default path selection heuristics.

FIG. 3 illustrates a flowchart of an alternative example method for implementing hierarchy metadata to improve relational model default path selection heuristics.

FIGS. 4A and 4B illustrate embodiments in which hierarchy metadata is used to improve relational model default path selection heuristics.

### DETAILED DESCRIPTION

Embodiments described herein are directed to implementing hierarchy metadata to improve relational model default path selection heuristics. In one embodiment, a computer system receives a database query from a user. The query is configured to return a portion of requested data stored in the database. The database includes multiple different data entities related to each other via different relationship paths. The computer system accesses hierarchy metadata that describes various database hierarchies, each hierarchy including multiple data entities. The computer system determines an optimal path between the related data entities based on the database query and the hierarchy metadata, and accesses the data using the determined optimal data entity relationship path.

In another embodiment, a computer system receives a database query from a user. The query is configured to return a portion of requested data stored in the database. The database includes multiple different data entities related to each other via different relationship paths. The computer system accesses hierarchy metadata that describes various database hierarchies, each hierarchy including multiple data entities. The computer system determines each relationship path between a starting entity and a target entity, compares unique portions of the relationship paths that are not shared between relationship paths, and removes those paths determined not to be an optimal path between the related data entities. The computer system determines an optimal path between the related data entities based on the database query and the hierarchy metadata, and accesses the data using the determined optimal data entity relationship path.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

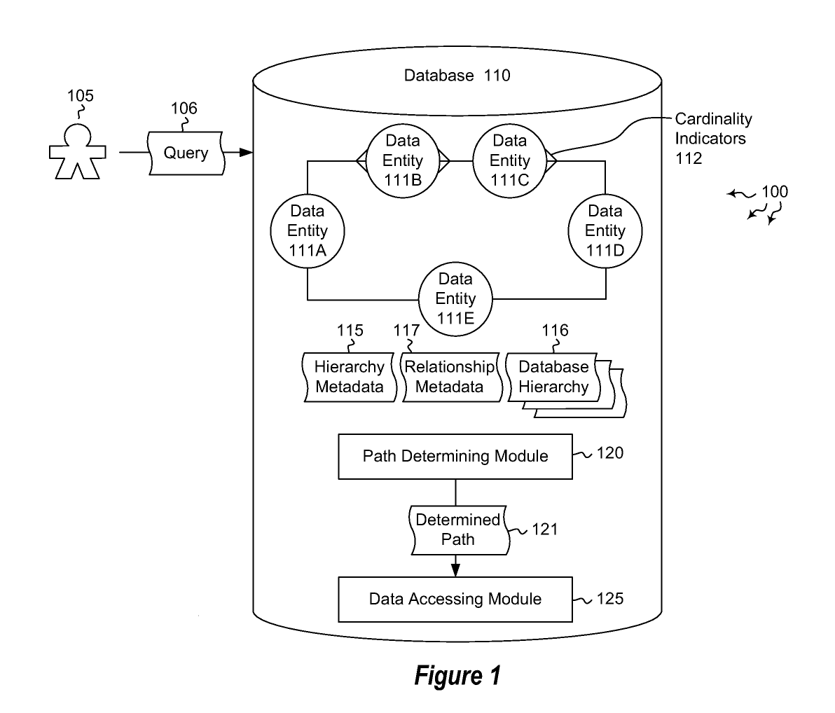

FIG. 1 illustrates a computer architecture 100 in which the principles of the present invention may be employed. Computer architecture 100 includes database 110. Database 110 may be any type of database configured to store and access information. In some cases, database 110 may be a relational database. The database may hold different types of information stored as data objects or data entities. For instance, database 110 may be configured to store data entities 111A-111E. These data entities are interrelated, as depicted by the interconnecting lines. Although five data entities are depicted in FIG. 1, it will be understood that database 110 may store substantially any number of data entities and that these entities may be connected by substantially any number of data relationships.

In some cases, the data relationships may include different cardinalities. These cardinalities may be indicated by cardinality indicators 112. A cardinality or relative cardinality may refer to a type of relationship one data entity has with another data entity. For example, a category entity may have a one-to-many relationship with a product entity, meaning that each category may have many products (e.g. the category “sporting equipment” may include products such as tennis rackets, basketballs and running shoes). Other cardinality types may include one-to-one, many-to-one, many-to-many, or other types. Thus, as shown in FIG. 1, data entity 111A has a one-to-many relationship with entity 111B and a one-to-one relationship with entity 111E. Data entity 111B has a many-to-one relationship with entity 111A and a many-to-one relationship with entity 111C. Using this framework, the relative cardinalities of data entities 111C, 111D and 111E are easily determined. It should be noted that these cardinalities were arbitrarily chosen and that different cardinalities may be used.

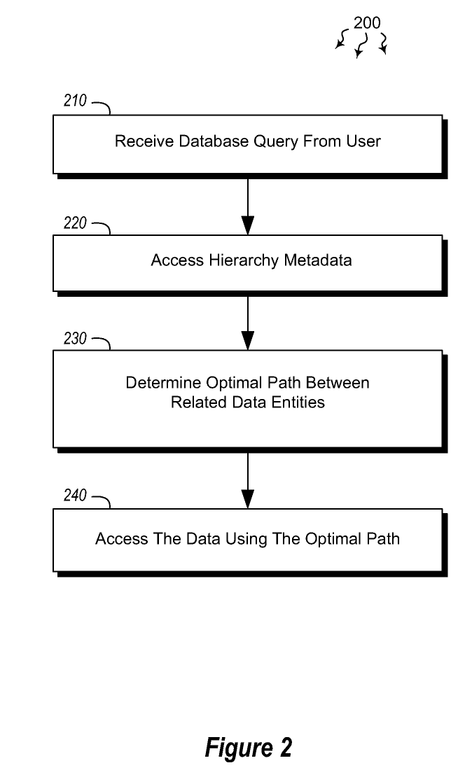

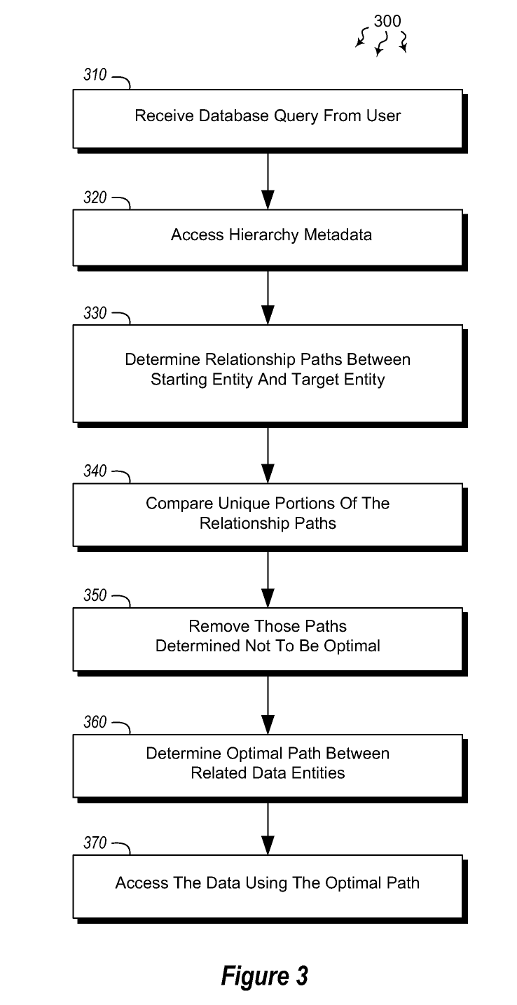

The database 110 may be configured to receive database queries 106 from users 105 or from other computer systems. In response to the queries, the database may begin determining which path to a given data entity is most likely to be desired by a user. Path determining module 120 may be used to determine an optimal path. Typically, an optimal path to a data entity stored in the database would include the least number of cardinality changes. For example, a cardinality change may include a change from one-to-one to one-to-many, or from many-to-many to many-to-one. Thus, if a data query is to begin searching related data entities and is to start with a given data entity, the path determining module determines the best path from the starting entity to the destination or target entity. The path determining module may use hierarchy metadata 115 and/or database hierarchy information 116 in its determination. Once the determined path 121 is chosen, data accessing module 125 can access the target data using the determined path. These concepts will be explained in greater detail below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

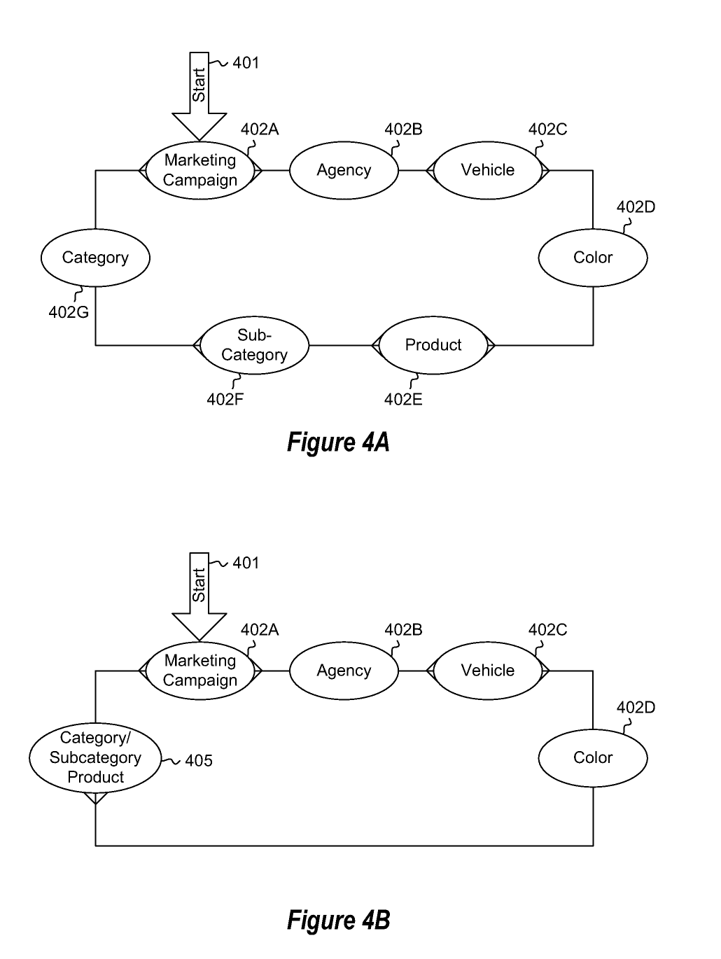

FIG. 2 illustrates a flowchart of a method 200 for implementing hierarchy metadata to improve relational model default path selection heuristics. The method 200 will now be described with frequent reference to the components and data of environment 100 of FIG. 1, as well as FIGS. 4A and 4B.

Method 200 includes an act of receiving a database query from a user, wherein the query is configured to return a portion of requested data stored in the database, the database including a plurality of data entities related to each other via multiple different relationship paths (act 210). For example, database 110 may receive query 106 from user 105. The query is designed to return a portion of requested data stored in the database. As mentioned above, database 110 may include substantially any number of data entities, including entities 111A-111E. The various data entities may be related to other data entities in the database and those relationships may include different cardinalities. The various links between data entities showing the relationships are referred to herein as roles. Cardinality differences in the roles may make some relationship paths less useful, less likely to represent meaningful relationships or more difficult to understand than others. In some cases, the data may be arranged or ordered in hierarchies. These hierarchies may be described in hierarchy metadata 115.

Method 200 includes an act of accessing a portion of hierarchy metadata that describes one or more database hierarchies, wherein each hierarchy comprises one or more data entities (act 220). For example, database 110 may access hierarchy metadata 115 which describes various database hierarchies 116 that exist among the data entities. A hierarchy may include any sequence, ordering or other arrangement of data in a database. One example of a hierarchy may include category, product and sub-product. In this example, the hierarchy may include “sporting equipment” as the category, “tennis rackets” as a sub-category and “children's tennis rackets” as a product. As will be understood, this is only one simplistic example of the many different types and varieties of hierarchies that may be used herein.

In some cases, the relationship metadata 117 may describe how the database data is to be queried. For instance, if certain relationship paths are to be used to access the data, the relationship metadata may specify such. In one example, the relationship metadata may identify a relationship path as being a preferred path. Other paths may be identified as non-preferred paths. In this manner, a user may specify their preferences regarding which relationship path should be used to access the data. As used herein, paths identified as preferred are to be given preference over non-preferred paths.

Method 200 also includes an act of determining an optimal path between the related data entities based on the database query and the hierarchy metadata (act 230). For example, path determining module 120 may determine an optimal path between related data entities 111A-111E based on the query 106 and the hierarchy metadata 115. Many different factors may be used in determining an optimal path including shortest path, path with the least number of cardinality changes or path with the least number of entities. Many other factors may also be used, including user preferences indicated in metadata.

In some cases, each relationship path between a starting entity and a target entity may be determined by comparing unique portions of the relationship paths that are not shared between relationship paths and removing those paths determined not to be an optimal path between the related data entities. Thus, for example, in determining an optimal path, if two portions of the path are the same, those portions can be removed from consideration. Then, only those portions that are different or unique will be compared to see which one is optimal. Those paths determined to be less than optimal are removed.

In some embodiments, determining each relationship path between the starting entity and the target entity may include determining each role between the starting entity and the target entity. Determining each role between the starting entity and the target entity may include accessing each of the entity's ancestor roles in the path between the starting entity and the target entity. Each of the entity's ancestor roles may be accessed to determine the cardinality of the roles between entities, as well as determining other information such as hierarchy and preference information. For instance, path determining module 120 determines, for each role, whether the role is preferred or non-preferred.

The relationship paths may be sorted based on how many preferred roles each path includes. Thus, paths with a higher number of preferred roles may be sorted higher on a preferred paths list than those paths with a lower number of preferred roles. As indicated previously, path determining module 120 may determine, for each path, the number of cardinality changes in the relationship paths. These paths may also be sorted based on how many cardinality changes each path includes. Paths with a higher number of cardinality changes will be sorted lower on a preferred paths list than those paths with a lower number of cardinality changes. In one example, if at least one of the relationship paths includes less than two cardinality changes, those relationship paths with two or more cardinality changes are automatically removed.

Determining the number of cardinality changes in the relationship paths may include determining which entities are members of a hierarchy based on the hierarchy metadata. For instance, as shown in FIG. 4A, a query may start at start 401 with marketing campaign 402A. In this example, two paths are available: Path 1 from marketing campaign 402A to agency 402B to vehicle 402C to color 402D (the target entity), or Path 2 from marketing campaign 402A to category 402G to sub-category 402F to product 402E to color 402D. In this example, Path 1 includes a one-to-many cardinality change between 402B and 402C and a cardinality change between 402C and 402D, for a total of two cardinality changes. The portion of Path 1 between 402A and 402B would not be considered a cardinality change because it represents an initial cardinality in the path. Path 2 includes a many-to-one cardinality change and a one-to-many cardinality change between 402G and 402F, and a many-to-one cardinality change between 402E and 402D, for a total of two cardinality changes. Thus, because both paths include two cardinality changes, other factors may be used in determining an optimal relationship path.

Accordingly, in some embodiments, determining the number of cardinality changes in the relationship paths may include ignoring those entities that are determined to be members of a hierarchy, so that those entities that include cardinality changes and are members of the hierarchy are not used in determining the number of cardinality changes in the relationship paths. Thus, as is shown in FIG. 4B, in cases where 402G, 402F and 402E are part of a category (as indicated by hierarchy metadata 115), category, sub-category and product may be combined in 405 so that there are no cardinality changes between 405 and 402D (target entity). Such a path is referred to herein as a “hierarchically simplifiable path” as cardinality changes belonging to nodes in a hierarchy can be ignored, thus simplifying the path.

Accordingly, as can be seen, Path 2 (a hierarchically simplifiable path) becomes a much better candidate for being the optimal path between the start and the target node. It should be noted, however, that other factors such as user preference may be taken into consideration when making the overall determination of which path is optimal. In some cases, hierarchically simplifiable paths may be ranked higher than complex (i.e. non-hierarchically simplifiable) paths, and simple paths (i.e. paths with no cardinality changes) are ranked higher than hierarchically simplifiable paths. These rankings are used to determine which path is the optimal path. After the optimal path, other paths may be ranked as closest to optimal, next closest, and so on. In some cases, multiple paths may be equally optimal. In such cases, the database may prompt the user for path selection and may present a portion of the top-ranked paths, or may present all the paths in a sorted order, indicating which paths tied with other paths in preferability.

Returning to FIG. 2, method 200 includes an act of accessing the data using the determined optimal data entity relationship path (act 240). For example, data accessing module 125 may access the target data (e.g. color 402D) using the determined optimal data entity relationship path 121. As shown in FIG. 4, the path from start 401 through entities 402A and 405 to target entity 402D may be the optimal path due to that path being hierarchically simplifiable.

Turning now to FIG. 3, FIG. 3 illustrates a flowchart of a method 300 for implementing hierarchy metadata to improve relational model default path selection heuristics. The method 300 will now be described with frequent reference to the components and data of environment 100.

Method 300 includes an act of receiving a database query from a user, wherein the query is configured to return a portion of requested data stored in the database, the database including a plurality of data entities related to each other via multiple different relationship paths (act 310). For example, database 110 may receive query 106 from user 105. The query may be designed to return a portion of requested data stored in various data entities in the database.

Method 300 includes an act of accessing a portion of hierarchy metadata that describes one or more database hierarchies, wherein each hierarchy comprises one or more data entities (act 320). For example, path determining module 120 may access hierarchy metadata 115 that describes or identifies database hierarchies 116. The database hierarchies identify data entities that are part of (or are arranged as part of) a hierarchy.

Method 300 includes an act of determining each relationship path between a starting entity and a target entity (act 330) and an act of comparing unique portions of the relationship paths that are not shared between relationship paths (act 340). For example, in FIG. 4A, the path determining module may start with entity 402A to determine each relationship path between 402A and target entity 402D. Any relationship paths that are the same may be removed or ignored. Thus, the unique portions of the relationship paths are compared. Those paths determined not to be an optimal path between the related data entities are removed (act 350).

Method 300 also includes an act of determining an optimal path between the related data entities based on the database query and the hierarchy metadata (act 360). For example, path determining module 120 may determine optimal path 121 between a start entity and a target entity based on both the query 106 received from the user and the hierarchy metadata 115, indicating which entities are part of a hierarchy. In some cases, the hierarchies are treated as preferred paths automatically. In other cases, each hierarchy may be treated as a semi-preferred path, so that preferred paths are ranked higher than semi-preferred paths and semi-preferred paths are ranked higher than non-preferred paths. Each hierarchy may be treated as a single node in a relationship path model, such that simple paths and hierarchically simplifiable paths are equally ranked. In some cases, hierarchies at the ends of a path may be ignored.

Method 300 includes an act of accessing the data using the determined optimal data entity relationship path (act 370). For example, data accessing module 125 may access the target data using the determined optimal path 121. In this manner, hierarchy metadata may be used to identify hierarchies and simplify relationship paths. The simplified relationship paths may thus assist in choosing which relationship path is optimal between any given start and target entities.

Thus, methods, systems and computer program products are provided which implement hierarchy metadata to improve relational model default path selection heuristics. The hierarchy metadata may be implemented to identify those entities that are part of a hierarchy, and thus identify relationship paths which may be simplified, leading to a better determination of an optimal data access path.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer networking environment including a plurality of computing systems, a computer-implemented method for implementing hierarchy metadata to improve relational model default path selection heuristics, the method comprising:
an act of receiving a database query from a user, wherein the query is configured to return a portion of requested data stored in the database, the database including a plurality of data entities related to each other via multiple different relationship paths;
an act of accessing a portion of hierarchy metadata that describes one or more database hierarchies, wherein each hierarchy comprises one or more data entities;
an act of determining an optimal path between the related data entities based on the database query and the hierarchy metadata; and
an act of accessing the data using the determined optimal data entity relationship path.

2. The method of claim 1, wherein determining an optimal path between the related data entities comprises the following:
an act of determining each relationship path between a starting entity and a target entity;
an act of comparing unique portions of the relationship paths that are not shared between relationship paths; and
an act of removing those paths determined not to be an optimal path between the related data entities.

3. The method of claim 2, wherein the act of determining each relationship path between the starting entity and the target entity comprises determining each role between the starting entity and the target entity.

4. The method of claim 3, further comprising an act of determining, for each role, whether the role is preferred or non-preferred.

5. The method of claim 4, further comprising an act of sorting the relationship paths based on how many preferred roles each path includes.

6. The method of claim 5, wherein relationship paths with one or more preferred roles are ranked higher than relationship paths with no preferred roles.

7. The method of claim 2, further comprising, for each path, an act of determining the number of cardinality changes in the relationship paths.

8. The method of claim 7, wherein if at least one of the relationship paths includes less than two cardinality changes, those relationship paths with two or more cardinality changes are removed.

9. The method of claim 7, wherein determining the number of cardinality changes in the relationship paths comprises determining which entities are members of a hierarchy based on the hierarchy metadata.

10. The method of claim 9, wherein determining the number of cardinality changes in the relationship paths comprises ignoring those entities that are determined to be members of a hierarchy, such that those entities that include cardinality changes and are members of the hierarchy are not used in determining the number of cardinality changes in the relationship paths.

11. The method of claim 1, wherein each hierarchy is treated as a preferred path.

12. The method of claim 1, wherein hierarchically simplifiable paths are ranked higher than complex paths and wherein simple paths are ranked higher than hierarchically simplifiable paths.

13. The method of claim 2, further comprising an act of prompting the user for path selection upon determining that multiple non-removed paths are available.

14. A computer program product for implementing a method for implementing hierarchy metadata to improve relational model default path selection heuristics, the computer program product comprising one or more computer-readable storage media having stored thereon computer-executable instructions that, when executed by one or more processors of the computing system, cause the computing system to perform the method, the method comprising:
an act of receiving a database query from a user, wherein the query is configured to return a portion of requested data stored in the database, the database including a plurality of data entities related to each other via multiple different relationship paths;
an act of accessing a portion of hierarchy metadata that describes one or more database hierarchies, wherein each hierarchy comprises one or more data entities;
an act of determining each relationship path between a starting entity and a target entity;
an act of comparing unique portions of the relationship paths that are not shared between relationship paths; and
an act of removing those paths determined not to be an optimal path between the related data entities;
an act of determining an optimal path between the related data entities based on the database query and the hierarchy metadata; and
an act of accessing the data using the determined optimal data entity relationship path.

15. The computer program product of claim 14, wherein each hierarchy is treated as a preferred path.

16. The computer program produce of claim 14, wherein each hierarchy is treated as a semi-preferred path, such that preferred paths are ranked higher than semi-preferred paths and semi-preferred paths are ranked higher than non-preferred paths.

17. The computer program product of claim 14, wherein each hierarchy is treated as a single node in the model, such that simple paths and hierarchically simplifiable paths are equally ranked.

18. The computer program product of claim 14, wherein hierarchies at the ends of a path are ignored.

19. The computer program product of claim 14, further comprising: an act of sorting the relationship paths based on how many preferred roles each path includes, wherein relationship paths with one or more preferred roles are ranked higher than relationship paths with no preferred roles.

20. A computer system comprising the following:
one or more processors;
system memory;
one or more computer-readable storage media having stored thereon computer-executable instructions that, when executed by the one or more processors, causes the computing system to perform a method for implementing hierarchy metadata to improve relational model default path selection heuristics, the method comprising the following:
an act of receiving a database query from a user, wherein the query is configured to return a portion of requested data stored in the database, the database including a plurality of data entities related to each other via multiple different relationship paths;
an act of accessing a portion of hierarchy metadata that describes one or more database hierarchies, wherein each hierarchy comprises one or more data entities;
an act of determining an optimal path between the related data entities based on the database query and the hierarchy metadata;
an act of determining each relationship path between a starting entity and a target entity;
an act of comparing unique portions of the relationship paths that are not shared between relationship paths; and
an act of removing those paths determined not to be an optimal path between the related data entities; and
an act of accessing the data using the determined optimal data entity relationship path.
